(19) United States
(12) Patent Application Publication
(10) Pub. No.: US 2017/0157511 A1
(43) Pub. Date: Jun. 8, 2017

(54) System and Method for Making One or More Toys User Interactive to Time of Day, Signal Strength and Frequency and to One Another

(71) Applicant: John Feghali, Pittsburgh, PA (US)

(72) Inventor: John Feghali, Pittsburgh, PA (US)

(21) Appl. No.: 15/369,157

(22) Filed: Dec. 5, 2016

Related U.S. Application Data
(60) Provisional application No. 62/263,497, filed on Dec. 4, 2015.
(60) Provisional application No. 62/379,420, filed on Aug. 25, 2016.

(51) Int. Cl. A63F 13/323; H04B 17/318; A63F 13/327; H04W 4/00

(52) U.S. Cl. CPC A63F 13/323; H04W 4/008; H04B 17/318; A63F 13/327

(57) ABSTRACT

A system and method for making one or more toy more user interactive. The system comprises a low energy signal emitting chip such as a Bluetooth® for each toy, a portable computing device such as a smart phone, tablet or laptop and software that sends a plurality of different commands to each toy depending on two or more of: a chronological event; relative strength of the signal received and frequency of occurrences the first toy has received one or more signals in a given time period.

### RELATED APPLICATIONS

This application claims priority to Provisional Application Ser. No. 62/263,497, filed on Dec. 4, 2015 and to Provisional Application Ser. No. 62/379,420, filed on Aug. 24, 2015 by the same inventor, both disclosures of which are fully incorporated by reference herein.

### FIELD OF THE INVENTION

1. Background

This invention relates to a system and method (including related software) for making one or more toys become “more” interactive depending on the time of day and relative distance from a reader device. More particularly, reactions from the toy (or toys) will purposefully vary depending on chronological input (time of day), signal strength and frequency of reader interactions.

2. Relevant Art

A representative prior art system was that shown and described in Giedgowd et al. U.S. Published Patent Application No. 20130059284. However, that disclosure merely calculated the time that an RFID tag entered the range of a reader and the length of time that has been around the toy. The present invention far exceeds the interactive nature of that earlier reference.

### BRIEF SUMMARY OF THE INVENTION

It is a principle object of this invention to bring life and “intelligence” to toys and objects by reactions with a reader's measured signal frequency and wireless signal strength emitted from the toy or object.

It is a further object to giving one or more toys/objects lifelike characteristics by studying the signal strength of an embedded wireless emitting chip in each toy or object. The signal emitted by the toy or object can be read by a mobile device/tablet/music device/wearable device with wireless signal reading and writing capabilities.

It is another object to bring life and “intelligence” to two or more toys/objects by creating a dialogue or conversation through a coordination done by a smart device according to this invention.

Furthermore, this invention should be able to give life-like characteristics to multiple toys and objects by making them communicate with one another by triggering sounds and or body movements based on remote coordination done by a smart device. The toys/objects would be separately communicating with the smart device through wireless signaling.

These objects and advantages may be accomplished with a system and method for making one or more toy more user interactive. The system comprises a Bluetooth® chip or a similar low energy signal emitting chip for each toy, a portable computing device such as a smart phone, tablet or laptop and software that sends a plurality of different commands to each toy depending on two or more of: a chronological event; relative strength of the signal received and frequency of occurrences the first toy has received one or more signals in a given time period.

### SUMMARY OF THE DRAWINGS

Further features, objectives and advantages of the present invention will be made clearer with the following detailed description made with reference to the accompanying drawings in which:

FIG. 1 is a chart depicting the relative distance and signal strength from a single toy or object to a receiver/reader, like a smart phone/tablet or wearable device;

FIG. 2 is a chart depicting how different reactions in a single toy or object would be triggered by signal strength according to this invention;

FIG. 3 is a table depicting how a toy or object may produce different reactions (not listed) when correlated with time of day and signal strength according to this invention;

FIG. 4 is a table depicting how a toy or object may produce different reactions depending on the frequency of crossing paths with a receiver in a day and the signal strengths of such intercepts;

FIG. 5 is a graphic depiction of the different types of potential sensors to be integrated into a toy or object for triggering a life-like behavior therein according to one embodiment of this invention;

FIG. 6 is a chart depicting the relative distance and signal strength from multiple toys (in this case 3) to a receiver/reader such as a smart phone/tablet or wearable device;

FIG. 7 is a chart depicting how, according to one embodiment of this invention, a cell phone/reader may be used to coordinate interactions between a toy cat and dog;

FIG. 8 is a chart depicting how different reactions in three different toys would be triggered by relative signal strength according to this invention;

FIG. 9 is a chart depicting how three different toys could be triggered to solicit an interactive “conversation” according to this invention; and

FIG. 10 is a graphic depiction of different types of potential interactions between a plurality of toys triggered by a reader according to one embodiment of this invention.

### DESCRIPTION OF PREFERRED EMBODIMENTS

### For One Toy

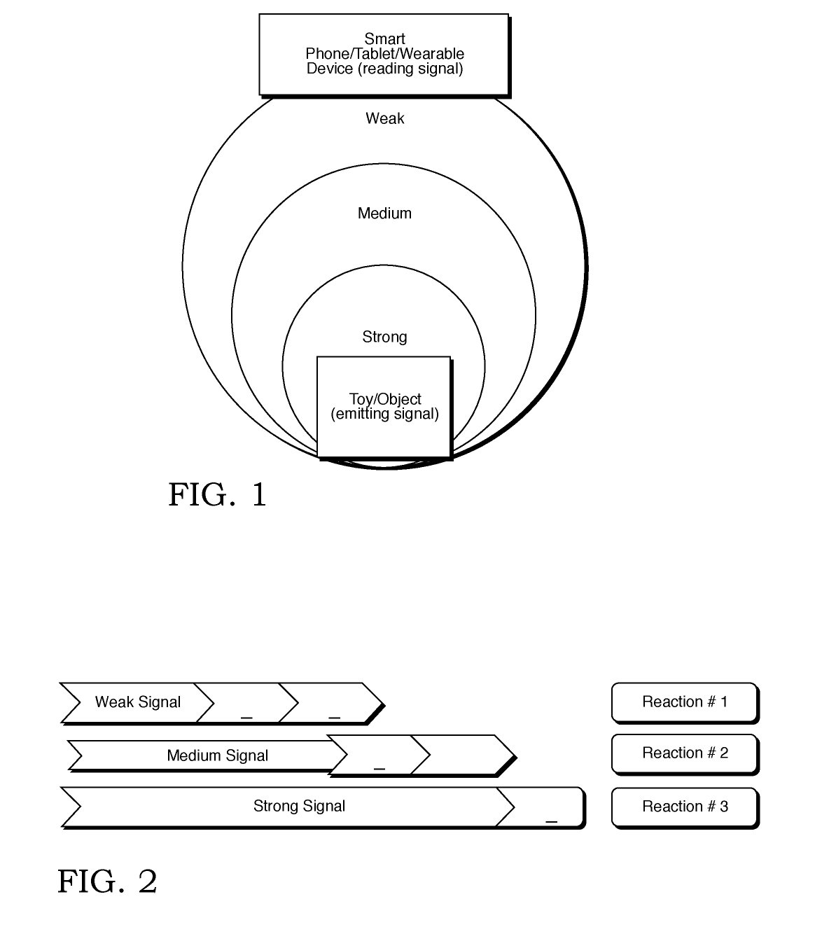

The invention consists of creating software that reads a signal strength coming from a toy or object on a mobile device or tablet or music device or a wearable device that has the capability to read emitted signals from other devices (hereinafter, such a device is called a “READER”). The signal strength read from the emitting source would be used to create an approximation of how far the toy/object is from the READER in order to trigger in that toy/object a behavior that gives it a life-like quality. See accompanying FIG. 1 for relative signal distances.

The life-like quality of the toy/object could be expressed in the form of: an emitted sound, a conversation phrase or word, light or body movement if the device has the capability of making a sound or play conversations, or has a light or a mechanism to induce movement.

The behavior expressed by the toy/object would depend on one or more of a series of criteria. The first such criteria is: how far the toy/object is from the READER, per accompanying FIG. 2. A different reaction will result (or otherwise be expressed in the toy/object) based on distance from the READER.

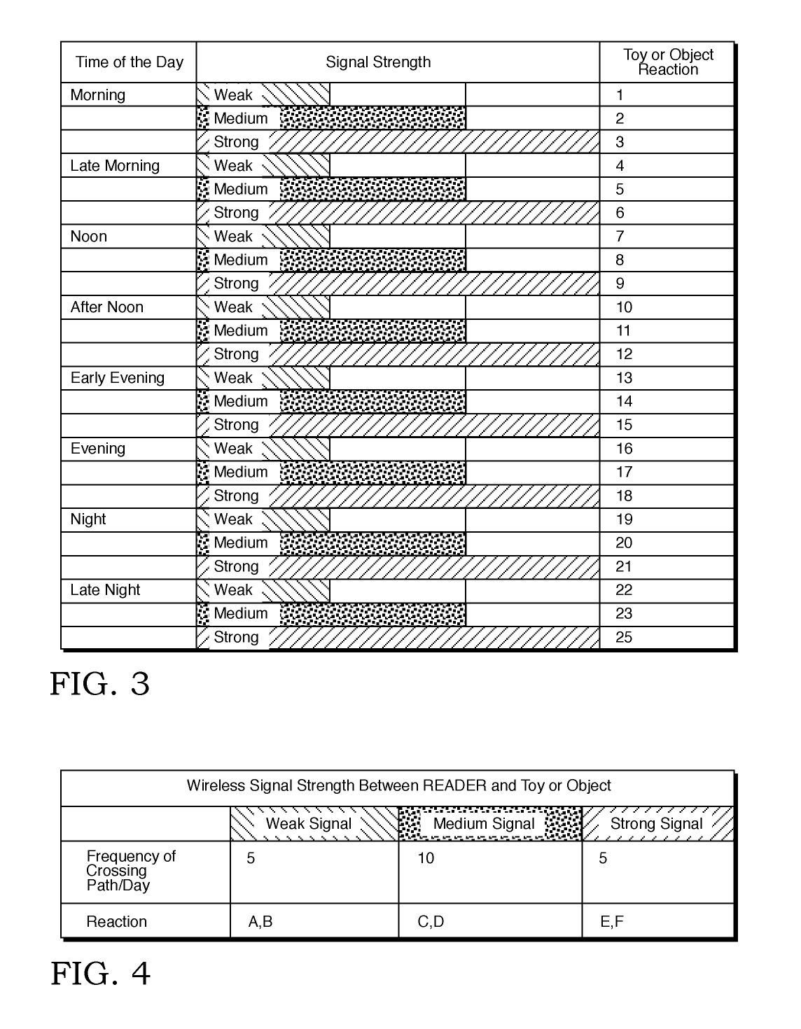

A second criterion to be considered in building life-like behavior is chronological, namely, the time of the day and day of the week. The software on the READER will read the time of the day and pair it with the signal strength between the READER and the toy/object to create a new set of reactions therefrom. The Table at accompanying FIG. 3 lists 24 potentially different toy/object reactions correlated by relative signal strength between READER and the toy/object, and by the relative time of day. Yet another variation may be combined therewith based on day of the week and/or calendar features for bringing in respective “holiday” interactions (including birthdays).

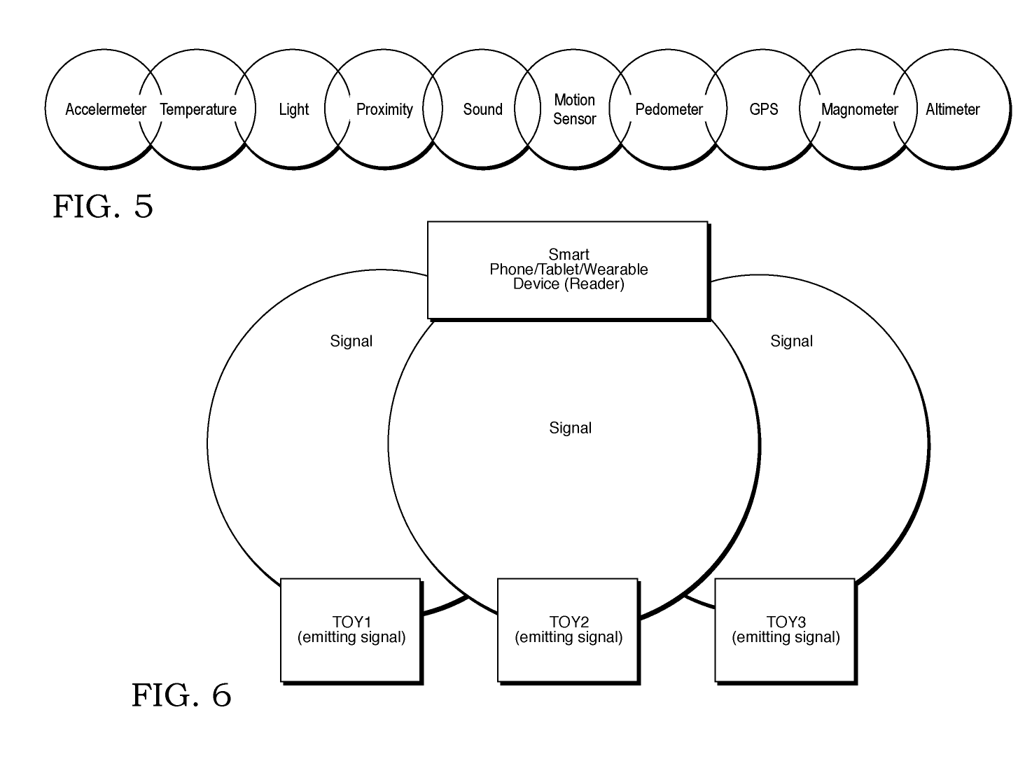

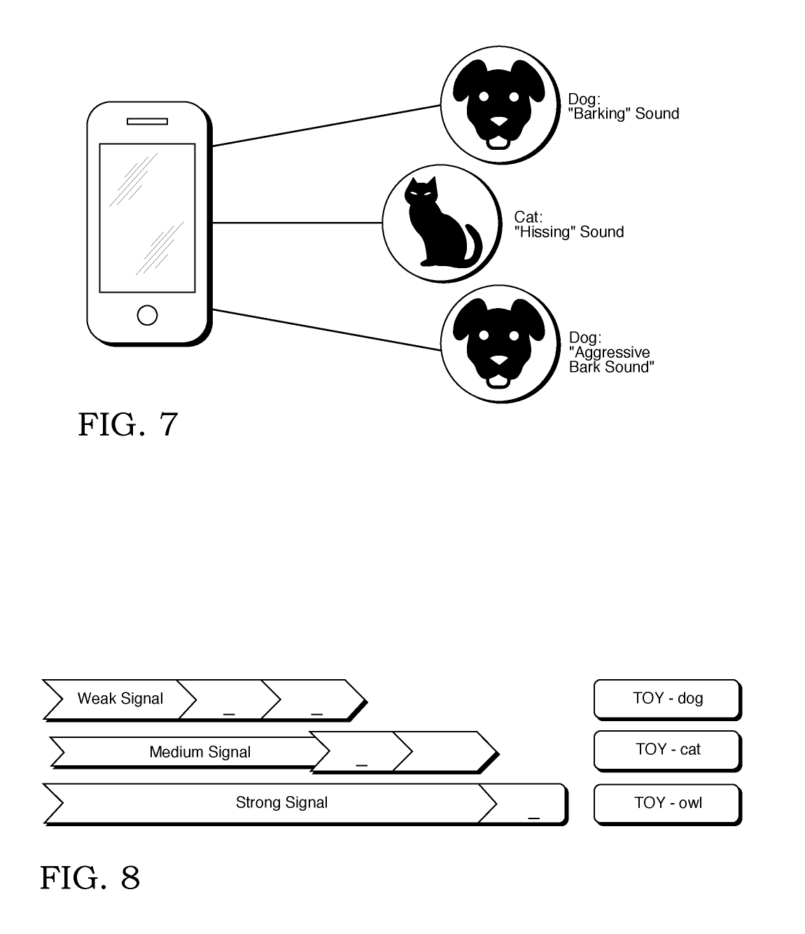

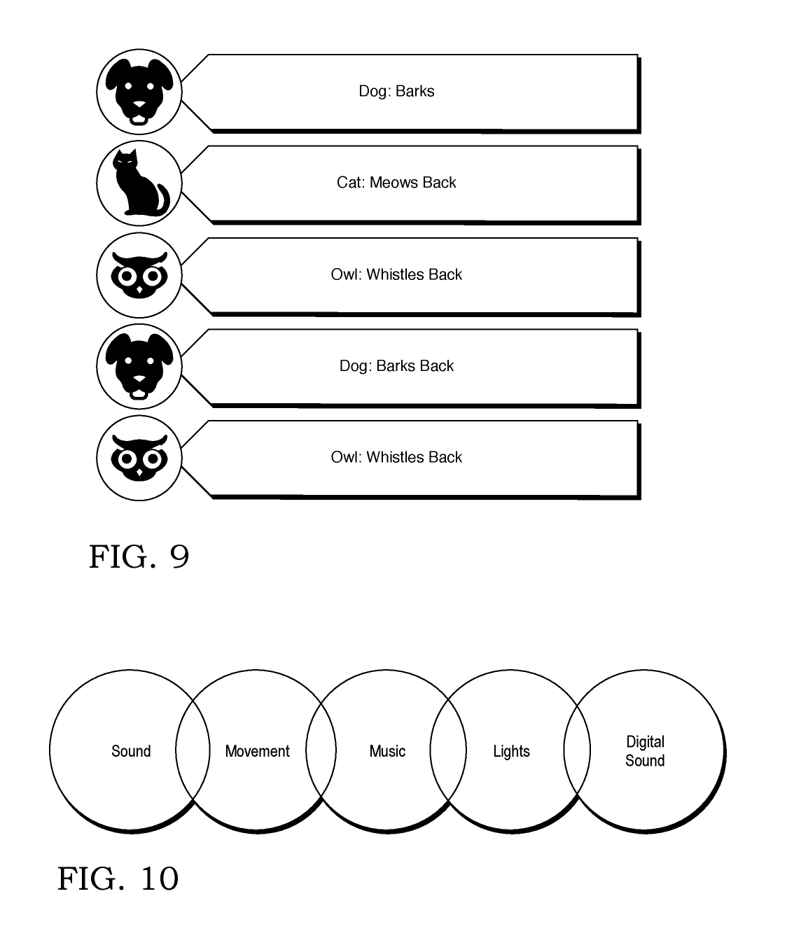

A third criterion in building life-like behavior is based on the frequency of times that the READER and Toy or Object cross path paired with the wireless strength signal when they cross paths. The Table at FIG. 4 adds this variable to the overall “mix” by factoring in the frequency of READER to toy/object interactions (or crossings of paths) in a given time period (such as one day) with relative signal strengths for causing different reaction sets (shown as AB for a Weak Signal/CD for a Medium Signal and EF for a Strong Signal). Accompanying FIG. 5 shows an example of different reactions based on certain times of the day in correlation to signal strength.

The life-like behavior on the toy/object can be triggered when it and the READER cross paths by entering into each ones area of wireless signal coverage or when the already crossed paths between the READER and toy/object leave their respective areas of wireless signal coverage.

The chip broadcasting the wireless signal on the toy/object could be built in into the toy/object OR it could also be added after the toy/object is purchased. A potential after-initial purchase wireless signal emitter unit could be stuck or attached to the outside (i.e., outer body) of that toy/object. Or, such a signal emitter can be made for embedding inside the toy/object.

In addition to a chip broadcasting the wireless signal, other life-like behaviors can be created by integrating more sensors on or into the toy/object. A representative list of sensors could include but not limited to accelerometers, temperature, light, proximity, sound, motion, pedometer, GPS, magnetometer, altimeter, etc. See, accompanying FIG. 5.

The different sensors would be paired with the signal strength, time of the day or week, frequency of encounter to create a whole set of new interactions. Interactions can come in many different formats, examples of interactions can include but are not limited to movement, sounds, conversations or phrases, lights, vibrations etc.

All data included in an emitted wireless signal from the toy/object will be processed by the READER. That READER would then send back a signal based on the intelligence and logic built into the software to trigger the life-like behavior on the toy/object.

The toy/object might also have its own built in intelligence software and the READER software in such a scenario would interact with the intelligent software on the toy/object to create a life-like behavior.

### For Two or More Toys

The invention consists of creating software that reads a wireless signal coming out of a series of toys or objects (hereafter a “TOY”) on a mobile device or tablet or music device or a wearable device that has the capability to read emitted signals from other devices (a “READER”). The signal read from the emitting TOY source would be used by the READER to coordinate a conversation with another TOY that is emitting its own wireless signal. The READER would recognize the presence of two or more TOYs and it will coordinate the trigger of sounds, voice text, music, or event movements to simulate a conversation or interaction between the two or more TOYs. The READER would take into account a series of factors into consideration to coordinate conversations including but not limited to: the number of TOYs that are in close proximity, the length of time the TOYs are within proximity of each other, the frequency of conversations that the TOYs have had in the past day/week/month/year, the type of TOY, the distance the TOYs are from one another.

Based on the wireless signals emitted from the different TOYs, the READER would trigger sounds, lights, movements that are built into the TOYs to simulate conversations, interactions, expressions of awareness.

The READER would trigger conversations or interactions in a synchronized way so as to simulate a real world conversation among the TOYs. The coordination from the READER usually leads to one TOY talking or playing sounds with or without movements while the other TOYs listening and then one of the listening TOYs would respond back by talking, playing sounds or making a physical movement or a combination of sound and movement. The back and forth exchange of sounds, music, lights and/or movements would create the perception that the TOYs are aware of one another and they are having a conversation among one another. The proposed approach to creating the perception of communication between TOYs through coordination from a smart device would reduce the cost of building TOYs that are able to communicate with one another and will also open up the opportunity to creating much richer and realistic interactions among TOYs. Also the wireless approach to coordination would ensure that the TOYs are able to have awareness and pretend to have conversations even when they are not within line of sight of one another.

The chip-broadcasting the wireless signal on the TOY could be built in into the TOY or it could also be added after the TOY is purchased. The added wireless signal emitter unit could be stuck or attached to the outside or outer body of the TOY or it could be embedded inside the TOY.

In addition to the chip-broadcasting the wireless signal, additional life-like behavior can be created by integrating more sensors in/on the TOY. A list of sensors could include but not limited to accelerometers, temperature, light, proximity, sound, motion, pedometer, GPS, magnetometer, altimeter, etc.

The different sensors would be paired with the signal strength, time of the day or week, frequency of encounter among different nearby TOYs to create a whole set of new interactions. Interactions can come in many different formats, examples of interactions can include but are not limited to movement, sounds, conversations or phrases, lights, vibrations etc.

All data included in the emitted wireless signal from the TOY will be processed by the READER. The READER would then send back a signal based on the intelligence and logic built into the software to trigger the life-like behavior on the TOY. The TOY might also have their own built in intelligence software and the READER software in such a scenario would interact with the intelligent software on the TOY to create a life-like behavior.

Additional data can be supplied to one or both toys depending on data received by one or more sensors included with one or both toys. Such sensors include, but are not limited to: an accelerometer, a temperature sensor, a light sensor, a sound sensor, a motion sensor, a pedometer, a GPS unit, a magnetometer and an altimeter

### Examples of the Invention

Example #1:

An example of the invention would be to bring life to a plush dog that a kid already owns. The invention involves adding a tag to the neck of the plush dog. The tag includes an accelerometer, a speaker and a Bluetooth® wireless chip.

To bring the plush dog to life, the Child will download a software on his/her smartphone and activate the Bluetooth® feature on his/her phone. The Child will pair the Bluetooth® device on the plush dog with his/her smartphone's Bluetooth®. Bluetooth® has a range between 50 and 150 feet. Once the Child's Smartphone reads the broadcast from the plush dog Bluetooth® unit (when the phone and the plush dog come into close proximity within less than the 50-150 feet range), the software on the phone will send a signal to the plush dog tag and based on the logic in the software, the tag starts making a barking sound.

If the Child happens to get very close to the dog (distance <3 feet), the signal strength read by the phone would be very high and the Dog tag in this case will make a sniffing sound based on the Bluetooth® signal sent back from the child's smartphone.

If the Child disappears from the Bluetooth® signal range and then shows up in the Bluetooth® signal range later in the evening, the Dog tag starts to make a sleepy sound. If the child happens to pick up the plush dog and rock it (triggering the accelerometer on the dog), the plush dog will fall asleep and the tag starts to make snoring sound.

If the plush dog is sleeping, once the child's smartphone gets closer to the dog, the dog will make a sleeping sound. The “sleeping” sound trigger will be activated by a signal sent from the software on the smartphone to the tag via Bluetooth®.

Example #2:

A truck that has a built in Bluetooth® chip, a speaker, an accelerometer and a set of lights. The Kid will download a gaming software application on their smartphone that connects through the phone's Bluetooth® to the truck's Bluetooth® chip. The Kid will program the truck to make an engine starting sound as his smartphone gets close to the truck to signal that it is ready to play with the kid. The truck's engine will turn off as the Kid moves away from the truck's Bluetooth® coverage signal area.

The truck will also trigger a horn sound if the Kid's smartphone gets too close to it. The truck can also make different sounds and turn on its lights at night to signal to the Kid that it wants to play as the Kid's smartphone get in close proximity with the truck's Bluetooth® area of coverage.

Example #3:

An elderly individual wears a small bracelet that has Bluetooth® wireless sensor on it. The bracelet is intended to interact with a robotic creature that would communicate with the elderly individual and encourage him or her to take their medicine and weigh themselves on a smart scale on a daily basis.

As the elderly individual walks into Bluetooth® wireless signal range for the robot, depending on the time of the day, the robot will talk to the elderly individual and remind him\her to take their medicine and weight themselves. Once the elderly individual walks away from the Bluetooth® wireless signal range of the robot, the robot will talk to and encourage that elderly individual to come back for a chat later in the day.

The wireless signal strength analysis software coupled with the time of the day will help create a companion for the elderly and encourage them to take care of their own health.

Example #4:

An example of the invention would be to add value and liveliness to a Toy pet such as a plush dog. The toy dog in this case would have a built in Bluetooth® chip that can trigger a sound that is saved on a chip inside the dog. A smart device such as an Apple iPhone® can communicate with the dog through Bluetooth® signaling. Through a software application on the iPhone®, the iPhone® can connect to the dog and trigger sounds that are saved on the dog. The software application will also be able to connect to nearby similar toy pets made by the same manufacturer. The application on the iPhone® will connect to one of the dogs and trigger a sound such as a bark and after about a second the application will connect to the second dog and will trigger another sound bark in a way that seems that the two dogs are aware of one another and they are communicating with one another as real dogs would.

If two toy dogs happen to be in the same environment for the first time, one dog might growl at the other dog and the second dog will also respond with a growling sound too. The same two dogs might interact in a more friendly way, if they happen to have seen one another in the past.

What is claimed is:

1. A system for making a toy more user interactive, said system comprising:
a) a first toy having a low energy signal emitting chip that is capable of receiving a signal from a transmitter and generating a response relative to the signal received;
b) a portable computing device including: (1) a central processing unit; (2) memory coupled to the central processing unit; (3) a rechargeable or non-rechargeable battery to power the computing device; (4) a wireless connectivity adapter coupled to the central processing unit for providing wireless connectivity to one or more devices when brought in proximity to the computing device; and (5) an internal database of signal responses for sending to the first toy depending on its relative proximity to the computing device; and
c) software on the computing device that sends a plurality of different commands from the internal database for the first toy to generate different responses depending on two or more of: a chronological event; relative strength of the signal received and frequency of occurrences the first toy has received one or more signals in a given time period.

2. The system of claim 1 wherein the low energy signal emitting chip is added externally to the first toy.

3. The system of claim 1 wherein the low energy signal emitting chip is installed internally to the first toy.

4. The system of claim 1 wherein the generated response for the first toy is visual, audible or both.

5. The system of claim 4 wherein the generated response is a physical movement of one or more components of the first toy.

6. The system of claim 1 wherein the software is capable of signaling a plurality of first toy responses for a chronological event selected from the group consisting of: a time of the day; a day of the week; a season of the year and a calendar event including a holiday and a programmable birthday or anniversary date.

7. The system of claim 1 wherein the software is capable of signaling a first response for a first time the first toy is brought in close proximity to the computing device for a first part of the day; and a second response for a second time the first toy is brought in close proximity to the computing device in a second part of the day.

8. The system of claim 1 wherein the software is capable of signaling a first response for a first time the first toy is brought in close proximity to the computing device for the day; and a second response for a second time the first toy is brought in close proximity to the computing device for the night.

9. The system of claim 1 wherein the software is capable of signaling a first response for a first time the first toy is brought in close proximity to the computing device for a first part of the day after a prolonged period of no interaction with the first toy.

10. The system of claim 1 wherein the software is capable of signaling a first response for a first time a second toy with its own low energy signal emitting chip is brought in close proximity to the first toy.

11. A system for making two or more toys user interactive relative to each other, said system comprising:
a) a first toy having low energy signal emitting chip that is capable of receiving a signal from a transmitter and generating a response relative to the signal received;
b) a second toy having a low energy signal emitting chip that is capable of receiving a signal from a transmitter and generating a response relative to the signal received;
c) a portable computing device including: (1) a central processing unit; (2) memory coupled to the central processing unit; (3) a rechargeable or non-rechargeable battery to power the computing device; and (4) a wireless connectivity adapter coupled to the central processing unit for providing wireless connectivity to one or more devices when brought in proximity to the computing device; and
d) software on the computing device that sends a plurality of different responses for the first toy and the second toy to generate depending on two or more of: a chronological event; relative strength of the signal received and frequency of occurrences the first toy and the second toy has received one or more signals in a given time period.

12. The system of claim 11 wherein the generated response for the first toy is visual, audible or both.

13. The system of claim 11 wherein the generated response for the second toy is visual, audible or both.

14. The system of claim 11 wherein the generated response for the first toy and the generated response for the second toy include time sequenced verbal signals.

15. The system of claim 14 wherein the generated responses for at least one of the first toy and the second toy include a preprogrammed phrase, animal sound or mechanical noise.

16. The system of claim 11 wherein the generated response for the first toy, the second toy or both toys is conditioned on data received from one or more sensors on the first toy, second toy or both toys, said sensors selected from the group consisting of: an accelerometer, a temperature sensor, a light sensor, a sound sensor, a motion sensor, a pedometer, a GPS unit, a magnetometer and an altimeter.

17. A method for making one or more toys more user interactive, said method comprising:
(a) providing each toy with a low energy signal emitting chip that is capable of receiving a signal from a transmitter and generating a response relative to the signal received;
(b) providing a portable computing device including: (1) a central processing unit; (2) memory coupled to the central processing unit; (3) a rechargeable or non-rechargeable battery to power the computing device; (4) a wireless connectivity adapter coupled to the central processing unit for providing wireless connectivity to one or more devices when brought in proximity to the computing device; and (5) an internal database of signal responses for sending to the first toy depending on its relative proximity to the computing device;
(c) providing software on the computing device that sends a plurality of different commands from the internal database for the first toy to generate different responses depending on two or more of: a chronological event; relative strength of the signal received and frequency of occurrences the first toy has received one or more signals in a given time period;.
(d) reading a low energy signal emitting chip when brought in proximity to the first toy; and
d) executing a predetermined application associated with a low energy signal emitting chip to change behavior of the first toy depending on two or more of: the chronological event, detection of the relative strength of the signal received and frequency of occurrences the first toy has received one or more signals in a given time period.

18. The method of claim 17 wherein the generated response for the first toy, the second toy or both toys is conditioned on data received from one or more sensors on the first toy, second toy or both toys, said sensors selected from the group consisting of: an accelerometer, a temperature sensor, a light sensor, a sound sensor, a motion sensor, a pedometer, a GPS unit, a magnetometer and an altimeter.

19. The method of claim 17 wherein the software is capable of signaling a plurality of first toy responses for a chronological event selected from the group consisting of: a time of the day; a day of the week; a season of the year and a calendar event including a holiday and a programmable birthday or anniversary date.

20. The method of claim 17 wherein the software is capable of signaling a first response for the first toy and a second response for the second toy following the first response from the first toy, said first response and said second response being an audible conversation-like response to one another.
